(19) United States
(12) Patent Application Publication
(10) Pub. No.: US 2007/0278333 A1
(43) Pub. Date: Dec. 6, 2007

(54) Method and device for producing cement

(75) Inventors: Otto Jung, Huetschenhausen (DE); York Reichardt, Kaiserslautern (DE)

Correspondence Address: BIRCH STEWART KOLASCH & BIRCH, PO BOX 747, FALLS CHURCH, VA, 22040-0747, US

(73) Assignee: Gebr. Pfeiffer AG, Kaiserslautern (DE)

(21) Appl. No.: 11/336,897

(22) Filed: Jan. 23, 2006

Related U.S. Application Data
(63) Continuation of application No. PCT/EP04/06356, filed on Jul. 11, 2004.

(30) Foreign Application Priority Data
Jul. 23, 2003 (DE) DE 103 33 361.4

(51) Int. Cl. C04B 2/10

(52) U.S. Cl. 241/241; 106/765

(57) ABSTRACT

A method and device for producing cement is provided, whereby cement clinker and material containing sulfate and optionally, additional constituent parts are ground in a roller mill to the consistency of flour. In a separate apparatus, the sulfur-containing material is heated, dehydrated and calcined to a desired temperature, is conveyed into the roller mill immediately thereafter, where, together with the remaining constituent parts, it is ground.

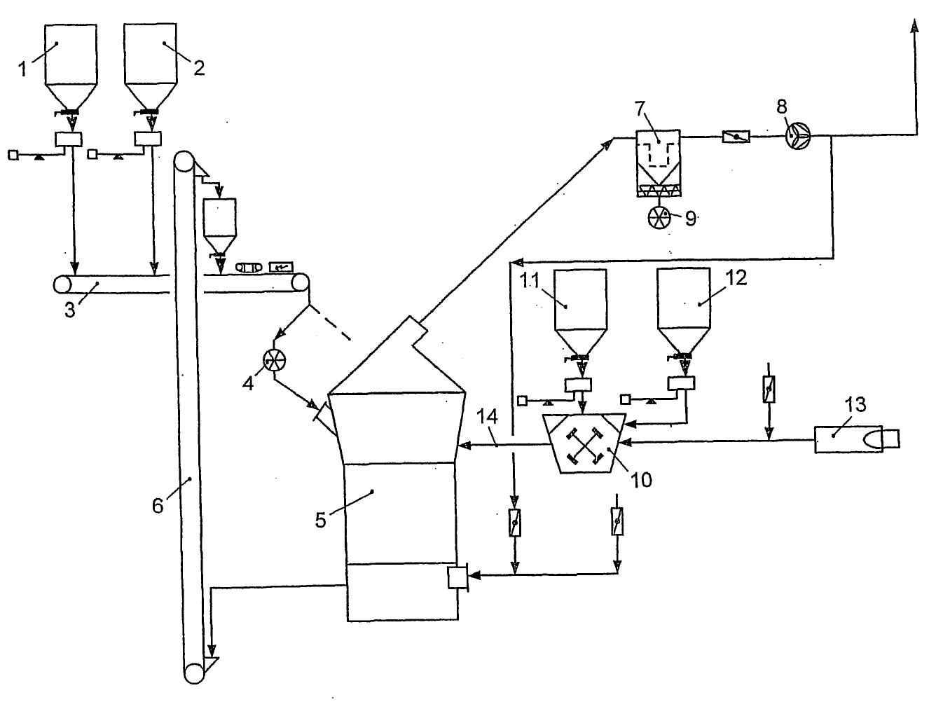

This nonprovisional application is a continuation of International Application PCT/EP2004/006356, which was filed on Jul. 11, 2004, which claims priority on German Patent Application No. DE 103 33 361.4, which was filed in Germany on Jul. 23, 2004, and which are both herein incorporated by reference.

### BACKGROUND OF THE INVENTION

1. Field of the Invention

The present invention relates to a method for producing cement and a device for the execution of the method.

2. Description of the Background Art

From DD-PS 201 137, a method is known for belite-rich cement with additives of sulfuric aggregates. The specific objective was thereby to achieve an effective cooling of the belite clinker and to improve the grindability. This was accomplished such that at a medium cooling gradient of the clinker between firing temperature and 800° C. in the cooling zone of the clinker, sulfur-containing aggregates with a particle diameter of less than 10 mm and at a quantity of up to 20 percent were added.

A further method and device for the manufacture of cement is known from DE 196 47 484 A. To reduce investment and energy costs for the manufacture of the cement, it is suggested therein to mix the still warm, that is, hot cement clinker with additives, particularly moist additives, and subsequently grind it, together with the additives, utilizing the waste heat from the exhaust air of the clinker cooler.

A further method for the manufacture of cement is known from DE 692 03 096 T, which corresponds to U.S. Pat. No. 5,449,404. It is suggested therein to add at least part of the gypsum needed for the manufacture of the cement to the clinker in the last section of the clinker cooler, which is the coldest section of the cooler. The amount of gypsum placed in the cooler should thereby be smaller than or equal to the smallest amount of gypsum required for the end product.

All three publications have in common that the sulfur-containing material, which is responsible for the calculated alteration of the cement properties, is added to the still hot cement clinker to achieve a faster cooling of the cement clinker and at the same time a dehydration and/or partial calcination of the sulfur-containing material without additional energy costs. The water solubility of the sulfur carrier is influenced by dehydration. It progresses from anhydrite to dihydrate to semi-hydrate. Furthermore, the degree of dehydration of the sulfur carrier has a direct impact on the initial and final strength as well as the setting speed of mortar made with cement such as this.

As attractive as the method of the three previously mentioned publications may appear at first glance, namely, to bring about the dehydration and/or calcination of the sulfur carrier with the residual heat in the cement clinker and simultaneously the cooling of the clinker, it did not become widely accepted in the field because the results were inexact and rarely reproducible. Reasons for this are the non-reproducible heat transition between cement clinker and sulfur carrier because their mechanical and physical properties are essentially subject to coincidence, and the slow and inexact controllability of the cooling, calcination, and mixing process.

In ball mills, which were primarily used in the past and are still widely used today for the grinding of cement, temperatures of more than 80° C., sometimes of more than 120° C., occur due to the generated grinding energy. The dihydrate thereby clearly discharges water already, which was taken into consideration during actual operation in the adjustment of the sulfur carrier. In order to realize a comparable phase transformation of the sulfur carrier in modern devices with roller mills, the cement mill and its air sifter have to be heated, requiring considerable energy. Subsequently, the cement powder has to be cooled off in separate cement cooling devices. This method is therefore costly in energy and equipment.

If large amounts of moist additives are added to the cement, such as slag sand or limestone, which have to be dried, the heating of the roller mill is definitely necessary. In this case, the water-containing sulfur carrier can also be dried and/or calcined in the cement mill.

However, in cases where, aside from the sulfur carrier, none or only minimal amounts of water-containing additives are added, the heating of the cement mill to the aforementioned temperatures solely for the purpose of drying and/or calcining the sulfur carrier, which only accounts for less than 10 percent of the total, is much too elaborate and costly. For this reason, many cement manufacturers have shifted to purchasing the sulfur carrier in a semi-dehydrated form, for example, from the production of gypsum fiber boards, and to grind it in the cement mill, together with the cement clinker, without additional heat. However, the acquisition and storage of the semi-dehydrated gypsum is expensive as well as time- and energy-consuming. In addition, it is not available everywhere, and not always in sufficient quantities.

### SUMMARY OF THE INVENTION

It is therefore an object of the present invention to provide a method for the production of cement, whereby the sulfur carrier can be exactly dosed with respect to the degree of dehydration and/or calcination and with respect to the size of the particles and the quantity.

The present invention is based on an interconnected operation of a non-heated roller mill for the manufacture of cement and a separate apparatus, in which only the sulfur carrier is brought to the desired degree of dehydration. This separate apparatus is substantially smaller and can therefore be heated with minimal energy expenditure, for which the exhaust gases of the cement clinker cooler are preferably utilized. Due to the interconnected operation, all devices for dust removal from and intermediate storage of the sulfur carrier can be dispensed with.

According to an embodiment of the invention, the sulfur-containing material is pneumatically conveyed from the separate apparatus into the roller mill, that is, into an air sifter of the roller mill cycle. This only requires a pipeline.

According to a further embodiment of the invention, the sulfur carrier can also be pre-comminuted in the separate apparatus. The smaller the particle size, the faster the dehydration, and the easier the pneumatic conveyance into the cement mill.

Beneficially, the desired calcination temperature is adjusted via the temperature of the hot gas in the separate apparatus, that is, during the pneumatic conveyance from the separate apparatus into the mill and/or via the dwell time of the sulfur carrier in the separate apparatus.

The method of the present invention is particularly well suited for the manufacture of portland cement.

Devices for the execution of the interconnected operation method are also an object of the present invention.

If the sulfur carrier is already sufficiently comminuted, as is the case with gypsum from FGD-plants, for example, the separate apparatus for drying and calcining is, in its simplest form, a drum.

As an alternative, a riser reactor, a fluidized bed reactor, or a heated chute can be used, depending on the resources at disposal.

If, in addition, the sulfur carrier is to be comminuted, hammer mills, vertical roller mills, ball ring mills or the like are suitable for serving as the separate apparatus.

Suitable for the grinding of the mixture of cement clinker and dehydrated, or calcined sulfur carrier are vertical mills, high-compression roller mills, horizontal roller mills etc., that is, roller mills, where the material to be ground is exposed to only a minimal temperature increase.

In the roller mill, that is, in a designated air sifter, the cement can be cooled by the infeed of cool air, or ambient air. The amount of cool air can thereby be substantially greater than the amount of gas required in the separate apparatus for drying and/or dehydrating the sulfuric aggregates.

According to an embodiment of the invention, additional energy can be saved by providing the roller mill with an external conveyor circuit for the particles.

In a preferred embodiment of the invention, the blower for the process gas of the roller mill is a suction blower. This makes it possible to generate not only the process gas for the cement mill, but also the conveyor gas and, if need be, the process gas for the separate apparatus. In this instance, the separate apparatus is connected to the roller mill via a pneumatic conveyor pipeline.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, are not limitive of the present invention, and wherein the FIGURE illustrates an embodiment of the present invention.

### DETAILED DESCRIPTION

The FIGURE shows, purely schematically, a device for the manufacture of cement utilizing a roller mill 5, to which a measured amount of cement clinker 1 is conveyed via a dosing belt 3 and via a rotary valve 4. The cement mill 5 is equipped with an external conveyor device 6 for the particles.

Dry additives 2 are also conveyed into mill 5 via dosing belt 3 and rotary valve 4.

The cement powder ground in cement mill 5 is filtered out of the mill gas by a filter or cyclone 7 and can be discharged via a rotary valve 9.

The mill gas is generated in a suction blower 8.

The sulfur carrier, which can be in a variety of forms, for example, in the form of FGD gypsum, in the form of sulfur-containing stone or in any other form, is stored in a silo 11, from where it is transported to a separate apparatus 10. In this apparatus 10, the sulfur carrier 11 is dehydrated and calcined to a desired temperature. For this purpose, hot gas from a hot gas generator 13 is supplied to the apparatus 10. A suitable hot gas generator is a cement clinker cooler, for example.

Moist additives 12 can be dried in the separate apparatus 10 prior to being fed into the cement mill 5.

In the separate apparatus 10, sulfur carrier 11 and additives 12 can also be comminuted, if necessary.

From the separate apparatus 10, the dried and possibly comminuted material is transported via a pneumatic conveyor line 14 to the roller mill 5, where cement clinker, additives 2, 12 and sulfur carrier are jointly ground to a flour-like consistency.

Thanks to the interconnected arrangement of cement mill 5 and separate apparatus 10, the suction blower 8 can provide the process gases for mill 5 and for the separate apparatus 10 as well as the conveyance gas in pipeline 14, which renders the operation particularly economical.

Due to the fact that the amount of a sulfur carrier required for the production of cement is ≦10 percent, the separate apparatus 10 is thus small in size. Equally small is the amount of hot gas that is required for the drying and/or calcining of the sulfur carrier 11. Thus, the cement in the cement mill can also be systematically cooled if cool air, that is, ambient air is added. Due to the direct conveyance of the dried and possibly comminuted sulfur carrier, otherwise commonly used filters and silos are not needed. At the same time, the sulfur carrier is of an exact controllable particle size, and most importantly, can be fed in exact metered quantities so that the cement powder ground in the cement mill 5 is always of a uniform and exact defined quality.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing cement, the method comprising the steps of:
heating, dehydrating, and calcining the sulfur-containing material to a predetermined temperature in a first apparatus;
conveying the heated, dehydrated, and calcined sulfur-containing material to a roller mill; and
grounding cement clinker and the sulfur-containing material in a roller mill to a flour-like consistency,
wherein the first apparatus is separate from the roller mill.

2. The method according to claim 1, wherein the sulfur-containing material is pre-comminuted in the first apparatus.

3. The method according to claim 1, wherein the sulfur-containing material is pneumatically conveyed from the first apparatus to the roller mill.

4. The method according to claim 1, wherein water-containing additives are also dried in the first apparatus.

5. The method according to claim 1, wherein all of the cement is cooled in the roller mill or and air sifter thereof.

6. The method according to claim 1, wherein the predetermined calcination temperature is adjusted by a temperature of a hot gas from the first apparatus during pneumatic conveyance from the first apparatus into the roller mill and/or via the dwell time of the sulfur-containing material in the first apparatus.

7. The method according to claim 1, wherein the first apparatus is heated by the exhaust gases of a cement clinker cooling unit.

8. The method according to claim 1, wherein the cement is portland cement.

9. A device for producing cement, the device comprising:
a roller mill;
a silo for cement clinker;
a silo for sulfur-containing material;
a blower for the process gas of the roller mill;
a cyclone and/or a filter for separating the cement from the process gas;
a separate apparatus for drying, calcining, and for comminuting the sulfur-containing material;
a hot gas provider for drying and calcining the sulfur-containing material in the separate apparatus; and
a device for conveying the sulfur-containing material into the roller mill.

10. The device according to claim 9, wherein the separate apparatus is a drum.

11. The device according to claim 9, wherein the separate apparatus is a riser reactor.

12. The device according to claim 9, wherein the separate apparatus is a fluidized bed reactor.

13. The device according to claim 9, wherein the separate apparatus is a heated chute.

14. The device according to claim 9, wherein the separate apparatus is a hammer mill.

15. The device according to claim 9, wherein the separate apparatus is a vertical roller mill.

16. The device according to claim 9, wherein the separate apparatus is a ball ring mill.

17. The device according to claim 9, wherein the separate apparatus is a ball mill.

18. The device according to claim 9, wherein the roller mill is a vertical roller mill.

19. The device according to claim 9, wherein the roller mill is a high-compression roller mill with an air sifter.

20. The device according to claim 9, wherein the roller mill is a horizontal roller mill with air sifter.

21. The device according to claim 9, wherein the roller mill has an external conveyor for coarse material from the mill.

22. The device according to claim 9, wherein the blower for the process gas of the roller mill is a suction blower.

23. The device according to claim 9, wherein the separate apparatus is connected to the roller mill or an air sifter thereof by a pneumatic conveyor line.

24. The apparatus according to claim 9, wherein the separate apparatus also comminutes the sulfur-containing material.

25. The method according to claim 1, wherein additional constituent parts are ground with the cement clinker and the sulfur containing material.
